(19) United States
(12) Patent Application Publication
(10) Pub. No.: US 2008/0260091 A1
(43) Pub. Date: Oct. 23, 2008

(54) Medical installation and method pertaining thereto

(75) Inventor: Michael Maschke, Lonnerstadt (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 12/148,406

(22) Filed: Apr. 18, 2008

(30) Foreign Application Priority Data
Apr. 20, 2007 (DE) 10 2007 018 809.0

(51) Int. Cl. H05G 1/00

(52) U.S. Cl. 378/4

(57) ABSTRACT

The invention relates to a medical installation comprising a device for generating x-ray images or computed tomography images or positron emission tomography images or single-photon emission computed tomography images and a device for generating endoscopic images. The device for generating x-ray images or computed tomography images or positron emission tomography images or single-photon emission computed tomography images and the device for generating endoscopic images are designed as an integrated unit.

### CROSS REFERENCE TO RELATED APPLICATIONS

This application claims priority of German application No. 10 2007 018 809.0 filed Apr. 20, 2007, which is incorporated by reference herein in its entirety.

### FIELD OF THE INVENTION

The invention relates to a medical installation comprising a device for generating x-ray images or computed tomography images or positron emission tomography images or single-photon emission computed tomography images and a device for generating endoscopic images and also a method for generating x-ray images and endoscopic images.

### BACKGROUND OF THE INVENTION

x-ray or fluoroscopic investigations are some of the standard investigations in gastro-intestinal disorders and disorders of the esophagus in particular. In such investigations, in order to generate x-ray images, x-rays are transmitted onto an object, penetrate said object, some of said rays are reflected, some are absorbed in the tissue and generate continuous x-ray images on an image detector disposed behind the object. These images can be recorded and further processed using analog or digital technology, for example.

In such investigations, various x-ray devices are used, for example, over-couch and under-couch x-ray systems. In over-couch systems, the x-ray emitter is disposed above the patient couch and, in under-couch systems, it is mounted below it. The x-ray images are often generated using a supply of contrast agent.

In particular in cases where significant findings are detected in the x-ray images, an endoscopic investigation is often additionally arranged or required, and endoscopic images are also generated accordingly in addition to the x-ray images.

This also applies to computed tomography images (CT-images) or images produced by a device for positron emission tomography (PET) or for single-photon emission computed tomography (SPECT).

For this purpose, the patient is taken into a different investigation room which is specially equipped for carrying out the endoscopic investigation. There, the endoscopic images are generated, stored in a separate system and in some cases inspected. The expensive endoscopes have to be sterilized after the investigation, but due in particular to the glass fiber technology used, sterilization is costly and complicated, with the result that a residual risk of the transmission of infectious diseases such as hepatitis and HIV cannot be ruled out.

It is only with difficulty that the images from the endoscopic investigation and the x-ray investigation or of another aforementioned image-recording method can be compared since this means that the various imaging systems in which said images are stored have to be accessed, there being in addition, as a result of the spatial separation of x-ray and endoscopy facilities, various problems that occur with respect to comparability, for example, regarding image-registration, the patient's position and suchlike.

### SUMMARY OF THE INVENTION

The invention therefore addresses the problem of providing a medical installation which is improved in this respect.

To solve this problem, a medical installation of the type mentioned in the introduction is provided, which installation is characterized by the fact that the device for generating x-ray images or computed tomography images or positron emission tomography images or single-photon emission computed tomography images and the device for generating endoscopic images are designed as an integrated unit.

According to the invention therefore, the x-ray device or the fluoroscopy device or CT, PET or SPECT device is integrated with an endoscopic device or installation, thus avoiding the disadvantages of the systems that have existed hitherto, in which the patient has to be taken to a different room for an endoscopic investigation that may if necessary follow an x-ray investigation, for example, which is a time-consuming procedure and additionally restricts the comparability of the images. Furthermore, in an integrated x-ray and endoscopy unit it is possible to continue to generate x-ray images, even during the endoscopic investigation or during the endoscopic image-recording, in the context of conducting a check or to complement the endoscopic image data, for example. Moreover, without further ado, the generation of an endoscopic image can be directly combined with the generation of fluoroscopic images, without it being necessary, for example, to book the patient in for a separate endoscopic investigation in another room or take him there.

The device for generating endoscopic images is therefore configured according to the invention such that it is integrated with a further imaging device.

The integrated unit can be a hybrid system. In this case it is advantageously a completely integrated system, in which x-ray and endoscopy are closely inter-related from the onset, for example to the extent that a common control console is provided. This has the advantage that the technician or physician carrying out the imaging or an appropriate medical technology assistant only has to learn to operate a single console for the two different image-recording methods.

Advantageously, the medical installation has a combined imaging system, in particular a common computing device for image computation, for the integrated unit comprising the device for generating x-ray images or computed tomography images or positron emission tomography images or single-photon emission computed tomography images and the device for generating endoscopic images. Using such a combined imaging system, in or in the form of a control console, for example, the image-recording and processing is facilitated in an integrated manner for the two different imaging processes. Corresponding software can be optionally provided to allow the alignment of the images with one another or the selection of protocols for image recording.

The combined imaging system can have at least one interface, in particular at least one respective interface for recording and/or exchanging data and/or images from the device for generating x-ray images or computed tomography images or positron emission tomography images or single-photon emission computed tomography images and from the device for generating endoscopic images. Primarily, separate interfaces are provided for the x-ray images or the x-ray machine and the endoscopic images or the endoscope, for example. The respective image data or the images can then be input via said interfaces into a computing device of the imaging system. Different interfaces or two interfaces allow the data from x-rays or CT, PET or SPECT and endoscopy to be supplied simultaneously to a memory or computing unit of the imaging system without any time being wasted in order to support the simultaneous image recording or to allow fast input of the data into the processing units of the system and avoid any changeover procedures. Optionally, however, a combined integrated interface that serves the purpose of inputting the images and data both from the x-ray detector and the optical endoscope is also conceivable.

According to the invention, the combined imaging system can be configured for the processing and/or storage of data and/or images in the integrated unit, in particular for storage in the Digital Imaging and Communications in Medicine format (DICOM-Format). In this case, therefore, the fluoroscopy, CT, PET or SPECT images and the endoscopy images are processed and likewise advantageously stored together, that is, in an integrated manner, such that the respective images are available jointly without involving the considerable effort of finding and collating them in different systems. It is thus clear from the onset that these are related data from one investigation- or image recording procedure or patient. In the processing, common features of the images can be taken into account or the processing can ensue in parallel in an integrated manner with the result that it becomes possible to display the images and data from the different methods for an operator or user to inspect in an integrated manner, in a combined software package, for example, or arranged adjacent to one another. Storage is preferably according to a set format in order to allow comparison or exchange to take place later or with other hospitals.

Furthermore, the combined imaging system can be configured for the superimposition and/or segmentation and/or registration and/or merging of the images from the device for generating x-ray images or computed tomography images or positron emission tomography images or single-photon emission computed tomography images and from the device for generating endoscopic images in the integrated unit.

In this case, the imaging system can be used to display the endoscopic images superimposed with, for example, the x-ray images. Furthermore, it is possible to carry out segmentation, that is, breaking down the images into sections with respect, for example, to assigning them to particular anatomical regions. The images from the different imaging processes can be registered or merged with one another with the result that displays are obtained that show, in addition to the data or information for one process, the information for the other process, or part of said information. Thus the data become easier for a user to capture. It is considerably easier to compare data than it is on the other hand in systems in which the data are available separately and have to be compared manually.

The device for generating endoscopic images in the integrated unit can be configured with at least one disposable endoscope. A disposable endoscope offers the advantage that it can be manufactured more cheaply than conventional endoscopes and moreover, the problems related to sterilization, which was necessary hitherto, are avoided. With respect to the design of disposable endoscopes, there are various solutions, in which the endoscope is partially or fully replaced after an investigation or a series of investigations.

For example, the device in the integrated unit for generating endoscopic images can be configured with at least one endoscope, in which at least one part, in particular the front section, is configured such that it can be replaced and/or removed after the generation of endoscopic images. This means that the design of the endoscope is economical so that the replacement or removal is possible in an economically justifiable manner, and since the respective components are less robust and do not have to be designed for long-term use. For the front section of the endoscope in particular, replacement or the possibility of an exchange is particularly advantageous.

The medical installation, in particular a combined imaging system, can comprise automatic terminal detection for at least one endoscope of the device for generating endoscopic images in the integrated unit. The medical installation or console of a combined imaging system or a computing device thus has, for example, a “plug and play” connection, with which it is optionally possible, in conjunction with the appropriate software, for different disposable endoscopes or other endoscopes to be detected automatically and then be available for use. It is thus possible for different endoscopes to be connected to the medical installation according to the requirements of the respective investigation or image recording. This allows the medical installation to have universal application, for example, even when the system of disposable endoscopes used is changed.

The automatic terminal detection is advantageously used to detect the type of endoscope and/or for automatic and/or operator-assisted adjustment of image recording- and/or processing parameters assigned to the endoscope. It is therefore deduced by means of a terminal detection system, which may be a software-supported terminal detection system, as to the type of endoscope involved, that is, for example, whether it is a disposable endoscope or not or what type of disposable endoscope it is. The types of endoscopes may vary, according to manufacturers or key components or even according to the methods used, for example, for the image recording, on which these are based. It may be possible, in particular in conjunction with software, for the adjustment of parameters for generating the endoscopic images to be made automatically in conjunction with or subsequent to terminal detection. Furthermore, the parameters set can be displayed in a corresponding software window that is optionally activated automatically, or it can be made possible for an operator to adjust these parameters himself or change them. These can be parameters that are required for the image recording itself but they can also be parameters that relate to the subsequent image processing, for example, using a combined imaging system. To this end, the terminal detection is optionally configured as integrated software in a control software package for a combined imaging system or for an imaging system for the endoscope.

The terminal detection can be based on a mechanical and/or optical and/or electronic coding, in particular based on a coding according to the Radio Frequency Identification concept. Thus, for example, a Radio Frequency Identification tag (RFID tag) can be fitted to a disposable endoscope or a re-usable endoscope, which tag is subsequently read via the terminal detection or a combined imaging system when the endoscope is connected to a console, for example. The type of endoscope can be recorded on the tag or transponder itself or in software which contains, for example, data assigned to the transponder data. Furthermore, optical codings are conceivable, likewise mechanical codings, for example, a differentiation according to different mechanical connections of the endoscope. Optionally, different types of coding can be combined in order to guarantee reliable and assured detection.

In a device for generating endoscopic images comprising at least one disposable endoscope, this can be a disposable endoscope based on complementary metal oxide semiconductor image sensor technology (CMOS image sensor technology). Solutions based on CMOS technology are comparatively economical, with the result that an economical design is possible for the endoscope itself, and not only for a terminal detection system using an RFID transponder, for example.

DE 42 09 536, for example, discloses a CMOS imaging catheter. US 2006/026007 discloses the changing and removal of the front section of an endoscope in each patient. In U.S. Pat. No. 6,659,940, for example, elements of a CMOS endoscope comprising a light source are described.

According to the above, at least one endoscope of the device for generating endoscopic images in the integrated unit can be configured to comprise at least one light-emitting diode as a light source. Such a light-emitting-diode (LED) is particularly suitable as a light source in conjunction with a CMOS image-sensor.

The device for generating endoscopic images in the integrated unit can be configured to generate images of the digestive organs and/or the lung and/or the bladder and/or further organs. It is conceivable to have a device that, being an integrated unit, will allow an image to be generated using x-ray methods and an endoscopic method for different organs. It is also possible, however, to provide medical installations that are specifically designed for investigations of the bladder, for example, or of other organs, said installations allowing the insertion of an endoscopic instrument. This specific design may find expression in appropriate software being stored in a computing device of a combined imaging system, for example, also comprising a database containing anatomical information relating to the respective region or having access to such a database. Optionally, corresponding protocols for the investigations can also be stored in the combined imaging system.

A device for the generation of x-ray images that may optionally be provided in the integrated unit can be an over-couch x-ray system and/or an under-couch x-ray system. In over-couch systems, the x-ray emitter is disposed above the patient couch and the x-ray detector is below the patient couch. In these systems, there is often the option of operating the unit or the x-ray device by remote control from a radiation-protected room. Over-couch systems are very widespread in Europe.

Under-couch systems, in which the x-ray emitter is installed below the patient couch, exist alongside said systems. These are very popular predominantly in the USA.

Optionally it is also possible to provide x-ray devices that combine both methods, in which therefore an x-ray emitter is disposed both below and above the patient couch, this being optionally achieved using two different patient couches or two different x-ray systems, such as mobile C-arc systems, for example.

A device for generating x-ray images in the integrated unit can be configured as a robot-based x-ray system, in particular comprising an articulated arm. Such robotic systems offer particularly flexible image recording options, in which different systems can be provided, in which the robotic arm can vary very considerably in design, regarding the mounting and or articulation of the articulated arm, for example.

Where a device for generating computed tomography images is provided, said device can additionally be used to generate PET and/or SPECT images.

The invention further relates to a method for generating x-ray images or computed tomography images or positron emission tomography images or single-photon emission computed tomography images and endoscopic images, in which the x-ray images or computed tomography images or positron emission tomography images or single-photon emission computed tomography images and the endoscopic images can be generated using an integrated unit, in particular using a medical installation according to one of the preceding claims.

The generation of said images can be controlled by a scientist, a physicist for example, or by a medical technology assistant or other technician. It is also optionally possible for image recording to be monitored or carried out by a physician.

However, it is not essential for endoscopic images to be generated, but the actual generation of endoscopic images can be achieved by a computing device or a physician as a function of a prior evaluation of, for example, x-ray images generated beforehand. The characterizing feature, however, is that an integrated unit is used in the method according to the invention, with which both x-ray images or CT images, PET or SPECT images and endoscopic images can be generated. It is also possible to plan from the onset to take and generate, for example, both x-ray images and endoscopic images without there being any dependence on a prior evaluation of x-ray images that may have been generated.

The method may comprise the following steps, for example:
administration of contrast agent to at least one patient for whom the generation of images has been arranged,
positioning of the patient in respect of the device for generating x-ray images or computed tomography images or positron emission tomography images or single-photon emission computed tomography images,
automatic and/or operator-assisted generation of x-ray images or computed tomography images or positron emission tomography images or single-photon emission computed tomography images,
automatic and/or operator-assisted generation of endoscopic images.

Optionally all these steps can be carried out. Frequently a solution of contrast agent is administered to the patient, whereupon, for example, x-ray images are generated, in which the projected image of the contrast agent can be seen in the x-ray image. Optionally, PET and/or SPECT images can also be generated together with CT images. This of course ensues after the patient has been positioned on a patient couch or other patient-supporting device pertaining to the device for generating x-ray images or suchlike, which device is usefully identical with the respective patient couch in the integrated device for generating endoscopic images. In order to generate said images, a control device can be optionally provided in a computing device of the combined imaging system for the device for generating x-ray images and the device for generating endoscopic images. The generation of images can be fully automated. An entirely manual generation of x-ray images and of endoscopic images is also possible. Furthermore, in a method according to the invention, a combination of an automatic and operator-assisted generation of images is conceivable, in which, for example, a certain protocol is automatically suggested, whereupon the operator is given the option on a software interface to confirm this protocol or change certain parameters or, if necessary, select a completely different protocol.

After the generation, for example, of x-ray images or during the generation thereof, generation of endoscopic images can be achieved automatically and/or with operator assistance. The endoscopic images can be optionally generated on the basis of an evaluation of the or of certain x-ray images or of other images. If, for example, the evaluation of the x-ray images results in the finding that it no longer appears necessary to generate an endoscopic image, it is then possible to forego the generation of an endoscopic image. The evaluation can be achieved in a fully automatic manner using a computing device of the combined imaging system. The automatic evaluation can be optionally assisted or monitored by a technician with the relevant training or by a physician. A completely manual evaluation is also conceivable.

Accordingly, the generation of endoscopic images can be achieved on the basis of a manual and/or automatic evaluation of previously generated x-ray images or of other images. Optionally, no endoscopic images at all have to be generated, therefore.

Prior to the generation of endoscopic images, at least one endoscope can be inserted into the patient, in particular automatically, and/or after the generation of endoscopic images, said images can be evaluated and/or an intervention on the patient, in particular an endoscope-based based intervention, can optionally be carried out as a function of the evaluation and/or automatically using a control device. The above procedures can be carried out at least partially or even entirely by a computing device or a combined imaging system or a control unit. For the endoscopic intervention in particular and also optionally for the insertion of the endoscope, it is possible to have recourse to the services of a physician who will advantageously at least monitor said intervention or carry it out manually. In the context of such an intervention, it is possible, for example, to remove a polyp with a loop (polypectomy).

It is thus possible, using the medical installation or method according to the invention, to generate the images that are required for an investigation of the digestive organs, for example, entirely using an integrated device or in one room. The costs and the risk of infection for the patient can be reduced. The integrated unit allows a better and more clearly structured storage and processing of the image data that have been recorded.

### BRIEF DESCRIPTION OF THE DRAWINGS

Further advantages, features and details of the invention will emerge from the exemplary embodiments that follow and from the drawings, in which:

FIG. 1 shows a medical installation according to the invention having a combined imaging system,

FIG. 2 shows an integrated unit according to the invention, comprising an under-couch system,

FIG. 3 shows an integrated unit according to the invention, comprising an over-couch system,

FIG. 4 shows a further integrated unit comprising an over-couch system and

FIG. 5 shows a basic diagram showing the steps involved in the method according to the invention.

### DETAILED DESCRIPTION OF THE INVENTION

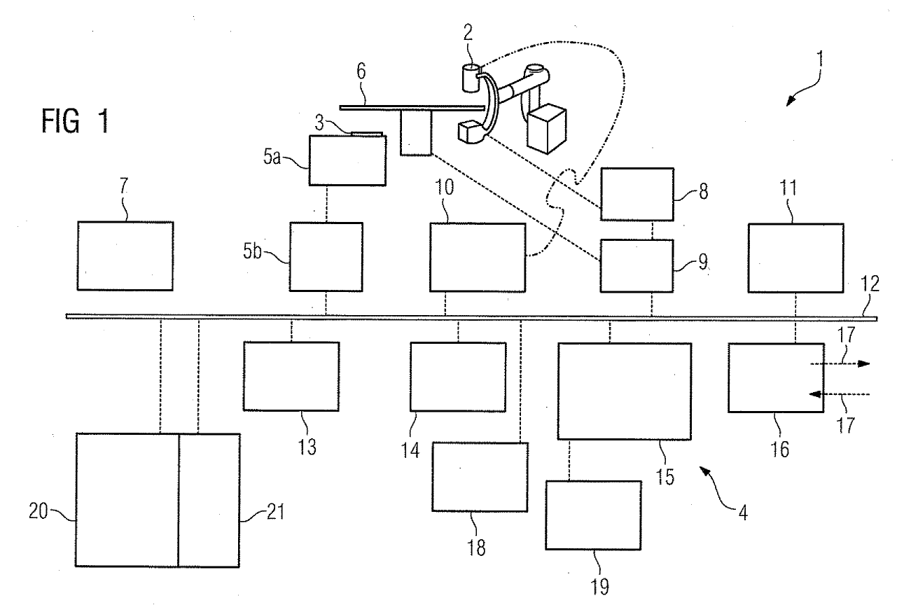

FIG. 1 shows an overview of a medical installation 1 according to the invention comprising a combined imaging system.

The medical installation 1 has a device for generating x-ray images and a device for generating endoscopic images, which devices are designed as an integrated unit. The device for generating x-ray images is formed of an x-ray system 2, whilst the device for generating endoscopic images has a port 3 for an endoscope that is not shown in any greater detail here.

The integration of the two devices is achieved in the present case essentially by the combined imaging system 4, which essentially includes the interfaces described hereafter and the image preparation and image processing units and memory. The port 3 for the endoscope is connected to a signal interface 5a for the endoscope. To record image data, an endoscope, which is not shown here, can be inserted into a patient who is located on the patient support 6 and is not shown here, in order to generate images of an organ that needs to be investigated.

The image data from the endoscope are forwarded from the port 3 via the signal interface 5a for the endoscope to the pre-processing unit Sb for the endoscope.

Furthermore, a power supply unit 7 is provided. A high voltage generator 8 provides the power supply for the x-ray system 2, said generator being additionally connected to the system control unit 9. A pre-processing-unit 10 is likewise provided for the x-ray images. This unit is supplied with images or data from the x-ray system 2. An image data memory 11 is used to store the data.

The image data memory 11, the system control unit 9 and likewise the pre-processing-unit 10 for the x-ray images and the pre-processing-unit 6 for the endoscopic images are connected to a databus 12, which forms the connecting component of the combined imaging system 4.

Furthermore, the combined imaging system 4 has an image-processing unit 13 for endoscopic images and an image-processing unit 14 for x-ray images. Furthermore, an image-merging unit 15 is connected to the databus 12, with the aid of which certain image-processing steps can be carried out, for example, segmentation, auto-segmentation and registration and reconstruction. There is a DICOM interface 16 for the patient data and image data. This is connected via the arrows 17 to a clinical information system, in order to allow the exchange of data. Furthermore, a calibration unit 18 and likewise an image correction unit 19 are provided for the image recording components.

The combined imaging system 4 further has a display unit 20 to display the optical endoscopic images and the x-ray images, which unit allows the display of said images, optionally following prior processing, showing combined registration by the image-merging unit 15, for example.

Furthermore, an operator input/output unit 21 which allows an operator to control the image data display or input parameters for the image-recording or select protocols and suchlike is provided.

It is thus possible using the medical installation 1 according to the invention to carry out the fluoroscopic and endoscopic investigation of a patient entirely in one room. The images generated, which are x-ray images from the x-ray system 2 and optionally endoscopic images, can be merged and directly registered in combination, as a result of which a simpler and more reliable evaluation is later facilitated.

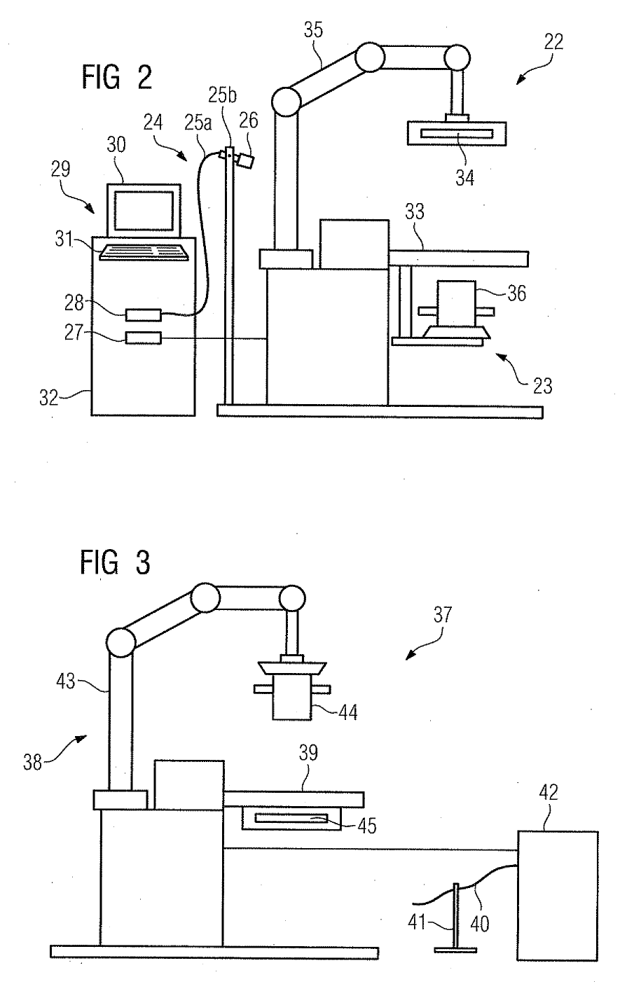

FIG. 2 shows an integrated unit 22 according to the invention, comprising an under-couch system 23. Furthermore, the integrated unit 22 has an endoscopic device 24 comprising a flexible component 25a, a support 25b and also an image recording component 26.

Both the under-couch system 23 and the endoscopic device 24 are connected via interfaces 27 and 28 to a combined imaging system 29. The combined imaging system 29 has an image display means 30 and also an input device 31, which are assigned to a computing device 32 of the combined imaging system 29. The input device 31 allows an operator to, for example, confirm or change parameters for the image recording that have been selected automatically by the computing device 32 or to control the image evaluation and change or evaluate the display of the image data that have been recorded.

The under-couch system 23 has a mobile and tiltable patient couch 33, in which the x-ray detector 34 is supported on a robotic arm 35. The fact that said detector is supported on a robotic arm 35, which is designed as an articulated arm, makes it possible to assume a plurality of positions with the x-ray detector 34. The x-ray emitter 36, which is assigned to the x-ray detector 34, is moveably mounted under the patient couch 33.

Using the integrated unit 22 which is shown here, it is possible in the hybrid system configuration to generate both x-ray or fluoroscopic images and endoscopic images and further process or evaluate them together.

FIG. 3 shows an integrated unit 37 comprising an over-couch system 38. The over-couch system 38 has, in the context of the integrated unit 37, a moveable and tiltable patient couch 39, on which the patient also continues to lie during an investigation with the endoscope 40. The endoscope 40 is flexibly constructed and supported on a support 41. The endoscope 40 and the over-couch system 38 are connected via an interface to a computing device 42, with which the image recording using the endoscope 40 and the over-couch system 38 is controlled.

The over-couch system 38 again has a robotic arm 43, on which the x-ray emitter 44 is supported. The x-ray emitter 44 works in conjunction with an x-ray detector 45 to generate an image, said detector again being mounted under the patient couch 39.

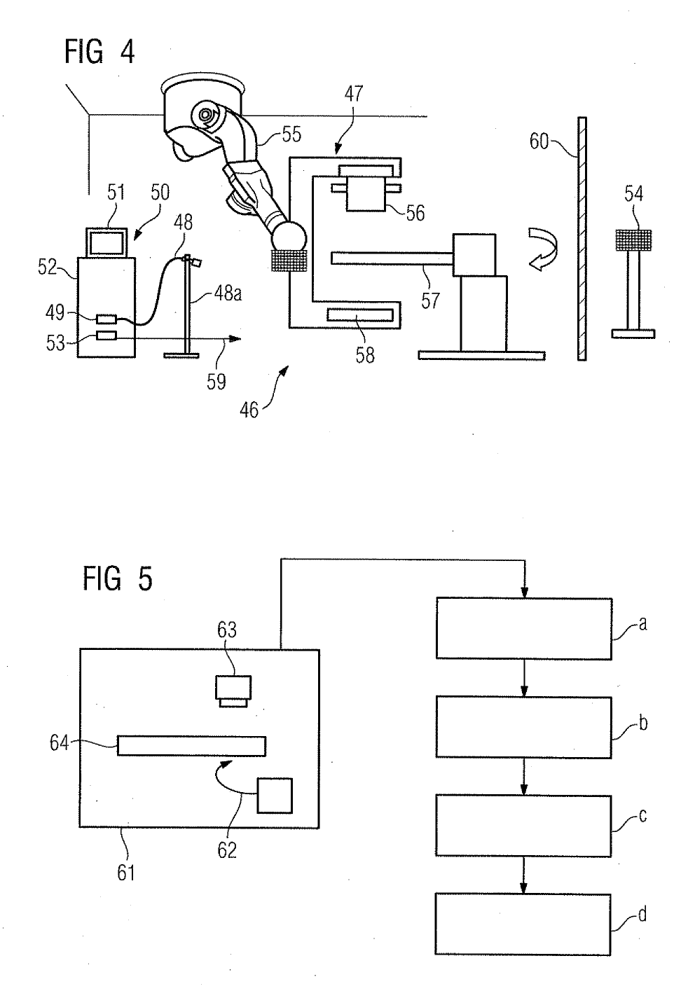

A further integrated unit 46 comprising an over-couch system 47 is shown in FIG. 4. Here, too, an endoscope 48, comprising a support 48a, is again connected to a combined imaging system 50 via an interface 49. The combined imaging system 50 comprises a monitor 51 and a computing device 52, there being a connection to the over-couch system 47 via an interface 53.

The over-couch system 47 is provided with a remote control 54, which allows inter alia the guiding of the robotic arm 55 on which the x-ray source 56 is arranged. The patient couch 57 is moveable and tiltable and is designed as a floor-mounted support. The x-ray detector 58 is arranged under the patient couch 57. The connection 59 between the combined imaging system 50 and the over-couch system 47 is indicated merely by an arrow here. Said connection should be configured in such a way that the possibility of moving the over-couch system 47 is not restricted as a result of the data link.

The remote control 54 furthermore allows the tilting of the patient support 57 and the emission of radiation by activating the x-ray source 56. Between the remote control 54 and the other components of the over-couch system 47, there is a radiation-protection wall 60 to protect the operator from the x-ray beam.

Finally, FIG. 5 is a basic diagram showing the steps involved in the method according to the invention, the key feature of the method being the integrated unit which is indicated in the box 61. The integrated unit combines an endoscope 62 and an x-ray device 63 into one room or one system. In step a of the method according to the invention, a contrast agent is administered to the patient at the instigation of the integrated unit 61. In step b, the patient is subsequently arranged or positioned on a patient couch 64 of the integrated unit 61. In step c, x-ray images are generated.

In particular in cases where significant findings are detected, an investigation with an optical endoscope is also conducted, according to step d. In the context of this investigation using a device in the integrated unit 61 for generating endoscopic images, the endoscope is optionally inserted either automatically or manually and the organ in question is investigated, for which procedure images are generated. Subsequent to this it is possible for an evaluation of the images to be carried out. Likewise it is possible for a diagnosis to be made, either by a physician or automatically using a computing device. An intervention such as the removal of a polyp with the aid of the endoscope 62 can be carried out later.

The use of the hybrid system combining a device for generating x-ray images or computed tomography images or positron emission tomography images or single-photon emission computed tomography images and likewise a device for generating endoscopic images offers the option of generating both x-ray images and endoscopic images in a simple manner and without having to move the patient to a different area for example.

1.-21. (canceled)

22. A medical installation, comprising:
an integrated unit that comprises:
a first device that generates a tomography image of a patient, and
a second device that generates an endoscopic image of the patient.

23. The medical installation as claimed in claim 22, wherein the integrated unit is a hybrid system.

24. The medical installation as claimed in claim 22, further comprising a combined imaging system for image computing.

25. The medical installation as claimed in claim 24, wherein the combined imaging system comprises an interface for generating or exchanging data from the first and the second device.

26. The medical installation as claimed in claim 24, wherein the combined imaging system processes or stores data in the integrated unit in a format of Digital Imaging and Communications in Medicine.

27. The medical installation as claimed in claim 24, wherein the combined imaging system superimposes, segments, registers, or mergers the tomography image from the first device and the endoscopic image from the second device.

28. The medical installation as claimed in claim 24, wherein the combined imaging system performs an automatic terminal detection of an endoscope of the second device that detects a type of the endoscope or adjusts a parameter of generating or processing the endoscopic image.

29. The medical installation as claimed in claim 28, wherein the automatic terminal detection is based on a coding selected from the group consisting of: a mechanical coding, an optical coding, and an electronic coding.

30. The medical installation as claimed in claim 22, wherein the second device comprises a disposable endoscope that is based on a complementary metal oxide semiconductor image sensor technology.

31. The medical installation as claimed in claim 22, wherein the second device comprises an endoscope having a replaceable or removable front section.

32. The medical installation as claimed in claim 22, wherein the second device comprises an endoscope having a light-emitting diode as a light source.

33. The medical installation as claimed in claim 22, wherein the endoscopic image comprises an image of an organ of the patient selected from the group consisting of: a digestive organ, a lung, and a bladder.

34. The medical installation as claimed in claim 22, wherein the first device comprises an over-couch or an under-couch system

35. The medical installation as claimed in claim 22, wherein the first device comprises a robot-based x-ray system having an articulated arm.

36. The medical installation as claimed in claim 22, wherein the tomography image is selected from the group consisting of: an x-ray tomography image, a computed tomography image, a positron emission tomography image, and a single-photon emission computed tomography image.

37. A method for generating a tomography image and an endoscopic image of a patient, comprising:
providing a first device to be used to generate the tomography image of the patient;
providing a second device to be used to generate the endoscopic image of the patient;
integrating the first and the second device into an integrated unit; and
generating the tomography image and the endoscopic image of the patient by the first and the second device in the integrated unit.

38. The method as claimed in claim 37, further comprising administering a contrast agent into the patient.

39. The method as claimed in claim 37, wherein the tomography image and the endoscopic image of the patient are automatically or operator-assistedly generated.

40. The method as claimed in claim 37, wherein the endoscopic image is generated based on a manual or automatic evaluation of the tomography image.

41. The method as claimed in claim 37, wherein the endoscopic image is evaluated and an intervention is automatically performed on the patient based on the evaluation of the endoscopic image.
